(19) United States
(12) Patent Application Publication
(10) Pub. No.: US 2005/0000756 A1
(43) Pub. Date: Jan. 6, 2005

(54) Combination brake system

(76) Inventor: Mehdi Biria, Edingen-Neckarhausen (DE)

Correspondence Address: Schwegman, Lundberg, Woessner & Kluth, P.A., P.O. Box 2938, Minneapolis, MN, 55402, US

(21) Appl. No.: 10/869,505

(22) Filed: Jun. 16, 2004

(30) Foreign Application Priority Data
Jun. 16, 2003 (DE) 203 09 375.5

(51) Int. Cl. B62L 5/00

(52) U.S. Cl. 188/26

(57) ABSTRACT

A combination brake system for two-wheeled vehicles (1) is described with a manually actuated hub brake (2) that is arranged on the rear wheel and a front-wheel brake (3) that can be actuated with the braking torque of the rear-wheel hub brake (2). In this case, the power transmission from the torque lever (5) of the rear-wheel brake (2) to the front-wheel brake (3) is realized by means of a degressive toggle mechanism (6) that operates near its extended position.

### The present application claims priority under 35 U.S.C. 119 to German Utility Model Application No. 203 09 375.5, filed Jun. 16, 2003, which is hereby incorporated by reference.

### FIELD

The invention pertains to a combination brake system for two-wheeled vehicles.

### BACKGROUND

Combination brake systems of two wheeled vehicles serve to safely and effortlessly actuate the wheel brakes, in particular, of bicycles. In such combination brake systems, the reaction torque generated during a braking maneuver by a rear-wheel brake that is conventionally actuated by means of a hand lever is used for actuating the front-wheel brake.

Due to these measures, both wheels can be decelerated by actuating only one brake lever. In addition, the utilization of the reaction torque generated during a braking maneuver by the rear-wheel brake for the actuation of the front-wheel brake results in a servo effect that makes it possible to achieve a significant braking effect with low actuating forces. With respect to the cycling safety, combination brake systems of this type are particularly advantageous if they make it possible to realize a certain ABS effect. This anti-blocking effect is achieved due to the fact that the rear wheel is alleviated during the blocking of the front wheel such that the reaction torque of the rear-wheel brake also diminishes. This in turn leads to a reduced braking effect of the front-wheel brake actuated by means of this reaction torque such that the front wheel is no longer blocked.

However, one encounters a problem in the practical utilization of combination brake systems, for example, according to DE 37 29 145, namely that they have an even higher tendency to hesitate, jerk and build up vibrations analogous to anti-blocking systems known from motor vehicles. Depending on the roadway condition, this may represent another safety risk.

In order to solve this problem, it has been proposed, for example, in DE 42 16 461 to incorporate a hydraulic damper into the brake system, wherein the hydraulic damper suppresses or dampens jerky movements of the brake components and the development and build-up of vibrations. However, the main disadvantage of utilizing a hydraulic damper can be seen in the fact that such a brake system is disproportionately complicated and consequently expensive. Although it would be desirable to utilize such safety brake systems in all types of bicycles, their price makes it impossible to correspondingly equip numerous bicycles in the lower and average price ranges. Consequently, there is a need for an improved brake system.

### SUMMARY

The present invention aims to develop a combination brake system, in which jerky responses and the undesirable development of vibrations are effectively prevented, namely without requiring, for example, complicated hydraulic components.

In an aspect of the present invention, a combination brake system for two-wheeled vehicles with a manually actuated hub brake that is arranged on the rear wheel and a front-wheel brake that can be actuated with the braking torque of the rear-wheel hub brake, wherein the power transmission from the torque lever of the rear-wheel brake to the front-wheel brake is realized by means of a degressive toggle mechanism that operates near its extended position. In an option, the toggle mechanism is arranged in the region of the rear wheel. In an option, the main bearing of the toggle mechanism is arranged on an auxiliary bracket. In an option, the auxiliary bracket is not rigidly connected to the vehicle frame, wherein the auxiliary bracket is supported on the rear wheel axle in a translatory fashion and on the vehicle framein a rotatory fashion. In an option, an adjustable limit stop is provided in order to adjust the home position of the toggle mechanism. In an option, the adjustable limit stop is arranged on the auxiliary bracket. In an option, a pull-back spring acts upon the toggle mechanism. In an option, the pull-back spring engages on the auxiliary bracket.

The combination brake system according to an aspect of the invention includes a hub brake that is arranged on the rear wheel and manually actuated, for example, by means of a hand brake lever or back-pedaling, as well as a front-wheel brake in the form of, for example, a rim brake that is actuated by the braking torque of the rear-wheel hub brake.

According to an aspect of the invention, the combination brake system in question is characterized in that the transmission of power from the torque lever of the hub brake to the front-wheel brake takes place by means of a degressive toggle mechanism. In this case, the toggle mechanism is operated near its extended position.

The utilization of a toggle mechanism that is also operated near its extended position makes it possible to achieve a characteristic of the entire system which very effectively prevents the development of undesirable jerky braking movements and the build-up of vibrations and oscillations, namely without requiring hydraulic damping elements. A toggle mechanism near its extended position has, in particular, an extremely high power transmission ratio. With respect to the present invention, this means that the input power in the extended position of the toggle mechanism can become arbitrarily high without additionally increasing the output power.

This alone decisively reduces the tendency of the brake system to hesitate or vibrate, namely because a powerful response of the rear-wheel brake does not lead to an equally powerful response of the front-wheel brake. This means that a torque limiting effect is achieved without requiring a separate power limiting element, for example, as it is the case with the state of the art according to DE 37 29 145.

The displacement transmission ratio of a toggle mechanism near its extended position is also extremely low. With respect to the present invention, this means that very slight input displacements on the toggle mechanism or very small angles of rotation of the torque lever in the rear-wheel brake result in large output displacements or large output angles of rotation, respectively. This decisively reduces the response time of the entire brake system, wherein the mass moments of inertia are simultaneously lowered and possible resonances are shifted to harmless, significantly higher frequency ranges.

In the context of the invention, it is inconsequential where the toggle mechanism is arranged on the two-wheeled vehicle. It would be conceivable, in principle, to arrange the toggle mechanism at any arbitrary location in the power transmission system between the rear-wheel brake and the front-wheel brake. According to one preferred embodiment of the invention, the toggle mechanism is arranged in the region of the rear wheel of the two-wheeled vehicle. This arrangement results in a simple design, in particular, because the torque lever of the rear-wheel brake can be directly connected to the toggle mechanism in this fashion.

According to another preferred embodiment of the invention, the main bearing of the toggle mechanism is arranged on an auxiliary bracket. According to a particularly advantageous additional development, the auxiliary bracket is not rigidly connected to the vehicle frame, but rather supported on the rear axle in a translatory fashion and on the vehicle frame in a rotatory fashion. This is particularly advantageous because the installation and adjustment of the brake system, as well as the installation and the removal of the rear wheel, are significantly simplified.

According to another preferred embodiment of the invention, the combination brake system comprises an adjustable limit stop for adjusting the home position of the toggle mechanism. The combination brake system can be adapted to different circumstances, for example, the existing brake characteristics, at a central location by means of the adjustable limit stop. In this case, it is particularly preferred to arrange the adjustable limit stop on the auxiliary bracket. This significantly reduces the risk of unintentionally adjusting the brake system, and a simple and robust design is simultaneously achieved.

According to another preferred embodiment of the invention, the combination brake system comprises a pull-back spring that acts upon the toggle mechanism. After a braking maneuver, the pull-back spring promotes the resetting of the entire brake system including the torque lever of the rear-wheel brake into the idle or neutral position. In one particularly preferred additional development, the pull-back spring engages on the auxiliary bracket. This also simplifies the design of the brake system, wherein the reliability is simultaneously improved and the susceptibility to breakdowns is reduced.

The invention is described in greater detail below with reference to the figures that merely show exemplary embodiments of the combination brake system.

### BRIEF DESCRIPTION OF DRAWINGS

The figures show:

FIG. 1 a bicycle equipped with an embodiment of the combination brake according to the invention in the form of a schematic side view;

FIG. 2 the region of the toggle mechanism of the bicycle according to FIG. 1 in the form of a more detailed side view, and

FIG. 3 a representation analogous to FIG. 2 of the region of the toggle mechanism shown in FIG. 2, namely in the form of a top view.

### DETAILED DESCRIPTION

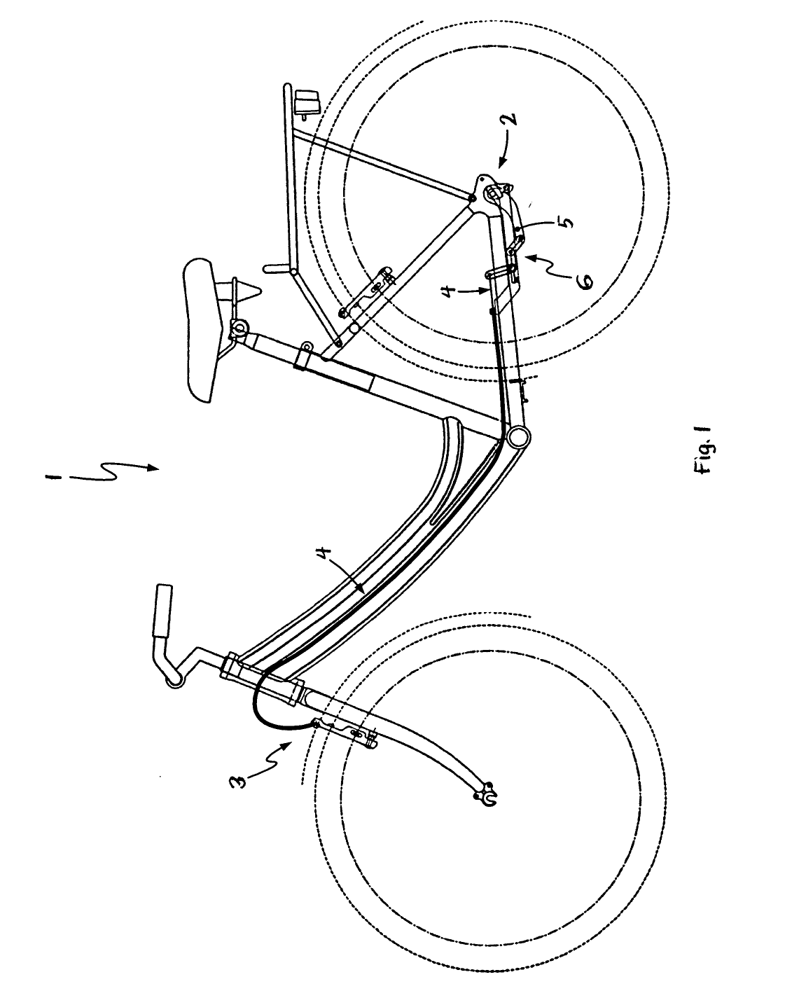

FIG. 1 shows a two wheel vehicle, such as a bicycle 2 with a rear-wheel hub brake 2 as well as a front-wheel rim brake 3. However, the bicycle shown in FIG. 1 is additionally equipped with an embodiment of the combination brake system according to the invention. The combination brake system connects the rear-wheel brake 2 to the front-wheel brake 3 via the Bowden wire 4.

In other words, the person riding the bicycle 1 only needs to actuate the rear-wheel brake 2, for example, by means of a not-shown, hand brake lever and a not-shown, additional Bowden wire, in order to initiate a braking maneuver. The braking torque generated during the thusly initiated deceleration of the rear wheel is transmitted to the Bowden wire 4 by means of the torque lever 5 of the rear-wheel brake 2, as well as the extended toggle mechanism 6. Consequently, the front-wheel brake 3 is actuated with the forces derived from the braking torque of the rear-wheel brake 2.

If the rear wheel is about to lift off the ground due to an excessively powerful application of the brakes such that the person riding a bicycle equipped with conventional brakes is at risk of nosing over the handlebar, the braking torque on the rear wheel is initially lowered and reduced to zero. However, this also eliminates the actuating force for the front-wheel brake 3 which is derived from the braking torque of the rear wheel. This makes it possible to prevent imminent nose-overs with a high degree of certainty.

Due to the reduced brake force on the front wheel, more weight is once again transferred to the rear wheel such that the braking torque on the rear-wheel brake 2 as well as the actuating force for the front-wheel brake 3 derived thereof are increased. In a two-wheeled vehicle equipped with such a combination brake system this servoloop between the braking torque on the rear wheel and the actuating force for the front-wheel brake 3 results in an ABS effect similar to that of anti-blocking systems known from the automobile industry.

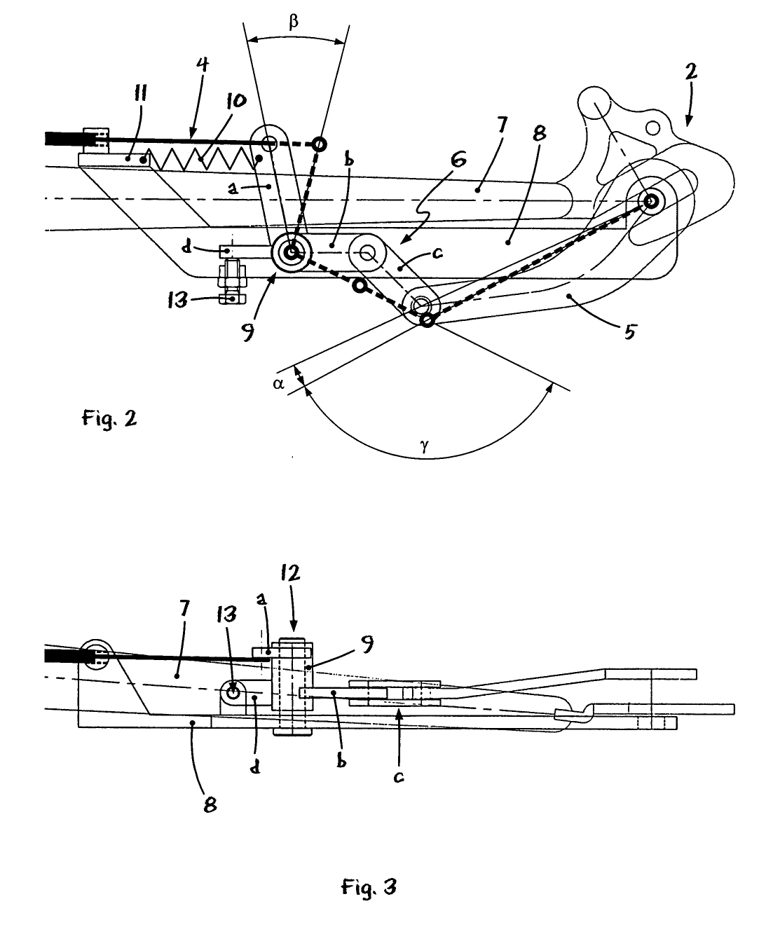

FIG. 2 shows an enlarged representation of the stay 7 that carries the bottom bracket bearing of the bicycle 1 according to FIG. 1, as well as the auxiliary bracket 8 arranged in this region, the torque lever 5 of the rear-wheel hub brake 2 that is not illustrated in greater detail and the toggle mechanism 6 that is connected to the auxiliary bracket 8 by means of the bearing arrangement 9 and comprises the main components a, b, c, d.

One can ascertain that the toggle mechanism 6 is operated near its extended position that is indicated with broken lines in FIG. 2. This means that an extremely high power transmission ratio on the one hand and an extremely low displacement transmission ratio on the other hand are achieved between the torque lever 5 of the rear-wheel brake 2 and the Bowden wire 4 leading to the front-wheel brake 3.

In other words, only a small fraction of the sometimes extremely high reaction torque or power on the torque lever 5 is transmitted to the Bowden wire 4 due to the largely extended position of the toggle mechanism 6, as well as the non-perpendicular application of force of the torque lever 5 on the toggle mechanism 6 under the angle γ. This is particularly important in modern front-wheel rim brakes that make it possible to already achieve a significant braking effect with very low actuating forces.

In addition, the torque lever 5 of the rear-wheel brake 2 is only displaced or turned by an extremely short distance or angle α between the home position and the maximum extended position of the toggle mechanism 6. Due to the associated reduction in the mass moments of inertia, this also contributes to preventing possible jerking and the build-up of vibrations caused by the brake system. When the torque lever 5 is turned by the angle α, the actuating lever a of the toggle mechanism 6 which actuates the Bowden wire 4 is turned by the actuating angle β that amounts to a multiple of the torque lever angle. This means that conventional front-wheel brakes 3, particularly rim brakes, can be smoothly actuated.

The operation of the toggle mechanism 6 near its extended position according to FIG. 2 also leads to a conceivably simple and extremely effective limitation of the actuating forces exerted upon the front-wheel brake without requiring additional assemblies. In the extended position of the toggle mechanism 6 which is illustrated with broken lines in FIG. 2, an additional increase in the force on the torque lever 5 of the rear-wheel brake 2 does not result in an additional increase of the forces applied to the front-wheel brake 3 by means of the Bowden wire 4.

In other words, the power transmission from the rear-wheel brake 2 to the front-wheel brake 3 by means of the toggle mechanism 6 not only results in a sensitive response of the entire brake system during slight braking maneuvers, but also in the desired torque limiting effect and the suppression of vibrations during powerful braking maneuvers. In addition, the toggle mechanism 6 also makes it possible to easily introduce extreme power peaks that may occur on the torque lever 5, particularly with back-pedaling brakes, directly into the auxiliary bracket 8 and directly into the rear structure 7 of the bicycle 1 via the stay 11. In addition, the front-wheel brake causes no reactions at all on the rear-wheel brake in the extended position. This also contributes to suppressing undesirable vibrations.

In order to promote the resetting movement, a pull-back spring 10 is arranged parallel to the end of the Bowden wire 4 between the auxiliary bracket 8 and the actuating lever a of the toggle mechanism 6.

FIG. 3 shows the arrangement according to FIG. 2 in the form of a top view. One can ascertain the chain stay 7 of the bicycle frame and the auxiliary bracket 8 arranged in this region. The bearing bolt 12 that carries a bearing sleeve 9 is arranged on the auxiliary bracket 8, wherein the two levers a and b of the toggle mechanism are arranged at a fixed angle relative to one another on said bearing sleeve. FIG. 3 also shows that the connecting element c is realized in a double-linked fashion similar to a chain link in order to prevent bending moments from being generated.

FIG. 3 in connection with FIG. 2 elucidates the design and function of the limit stop link d that is also arranged on the sleeve 3 and, in connection with the adjusting screw 13, serves for adjusting the home position of the toggle mechanism 6.

In summation, the combination brake system according to the invention combines a superior operational reliability, an anti-blocking effect and the suppression of vibrations in a very simple fashion, particularly due to the toggle mechanism that is operated near its extended position. In comparison with known combination brake systems according to the state of the art which frequently have a complicated design, are relatively susceptible to defects and require intensive maintenance, the combination brake system according to the invention has the potential for use in various bicycle categories due to its reliability, as well as its simple design.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

1. A combination brake system for two-wheeled vehicles with a manually actuated hub brake that is arranged on the rear wheel and a front-wheel brake that can be actuated with the braking torque of the rear-wheel hub brake,
characterized in that
the power transmission from the torque lever of the rear-wheel brake to the front-wheel brake is realized by means of a degressive toggle mechanism that operates near its extended position.

2. The combination brake system according to claim 1, wherein the toggle mechanism is arranged in the region of the rear wheel.

3. The combination brake system according to claim 1, wherein the toggle mechanism includes a main bearing, the main bearing is arranged on an auxiliary bracket.

4. The combination brake system according to claim 3, wherein the auxiliary bracket is not rigidly connected to the vehicle frame, wherein the auxiliary bracket is supported on the rear wheel axle in a translatory fashion and on the vehicle frame in a rotatory fashion.

5. The combination brake system according to claim 1, wherein an adjustable limit stop is provided in order to adjust the home position of the toggle mechanism.

6. The combination brake system according to claim 5, wherein the adjustable limit stop is arranged on the auxiliary bracket.

7. The combination brake system according to claim 1, wherein a pull-back spring acts upon the toggle mechanism.

8. The combination brake system according to claim 7, wherein the pull-back spring engages on the auxiliary bracket.

9. A brake system for a two wheel vehicle, comprising:
a front brake;
a rear brake; and
a degressive toggle mechanism operably connected to the rear brake and the front, the toggle mechanism having an extended position and being adapted to actuate the front brake upon activation of the rear brake in the extended position.

10. The brake system of claim 9, wherein the toggle mechanism includes a main bearing, the main bearing is arranged on an auxiliary bracket in a region of a rear wheel.

11. The brake system of claim 10, wherein the auxiliary bracket is supported on the rear wheel axle in a translatory fashion.

12. The brake system of claim 10, wherein the auxiliary bracket is supported on a vehicle frame in a rotatory fashion.

13. The brake system of claim 9, wherein the toggle mechanism includes a home position and an adjustable limit stop to adjust the home position.

14. The brake system of claim 13, wherein the adjustable limit stop is arranged on the auxiliary bracket.

15. The brake system of claim 14, wherein a pull-back spring acts upon the toggle mechanism.
